(19) United States
(12) Patent Application Publication
(10) Pub. No.: US 2024/0306534 A1
(43) Pub. Date: Sep. 19, 2024

(54) Method and Systems for Using Sensors to Determine Characteristics of Seeds or Particles

(71) Applicant: Precision Planting LLC, Tremont, IL (US)

(72) Inventors: William Frank, Manito, IL (US); Michael Strnad, Delavan, IL (US)

(21) Appl. No.: 18/575,900

(22) PCT Filed: Jun. 16, 2022
(86) PCT No.: PCT/IB2022/055586

§ 371 Date: Jan. 2, 2024

Related U.S. Application Data
(60) Provisional application No. 63/260,162, filed on Aug. 11, 2021.

(51) Int. Cl. A01C 7/10; G01N 21/85

(52) U.S. Cl. CPC A01C 7/105; G01N 21/85; G01N 2021/8592

(57) ABSTRACT

In one embodiment, an electrical control system (400, 450) comprises at least one sensor (800, 900) that is configured to illuminate multiple light sources (924, 926) with each light source having a different wavelength and to sense one or more products (832) flowing in a product line (822, 922) of an agricultural implement (10, 1240). Processing logic (416, 1226) is coupled to the at least one sensor and the processing logic is configured to obtain sensor data from the at least one sensor, to determine response signals for each product when illuminated based on the sensor data, and to analyze the response signals for each product to determine product characteristics including color of each product to distinguish each product.

### CROSS-REFERENCE TO RELATED APPLICATION

This application claims priority to U.S. Provisional Patent Application No. 63/260,162, filed 11 Aug. 2021, which is incorporated herein by reference in its entirety.

### TECHNICAL FIELD

Embodiments of the present disclosure relate to a method and systems for using sensors to determine characteristics including color of seeds or particles flowing through a seed or particle line of an agricultural implement.

### BACKGROUND

Air seeders have a primary distribution system and a secondary distribution system. Seeds and optionally fertilizer are fed from hoppers into the primary distribution system and are conveyed by air to the secondary distribution system. A manifold between the primary distribution system and the secondary distribution system divides the feed so that the secondary distribution system delivers seeds/fertilizer to each row. Seeds/fertilizer are conveyed by air.

Seed or fertilizer sensors on agricultural equipment have typically been optical sensors. When a seed or particle passes through the optical sensor a light beam is broken and a seed or particle is then detected. These sensors output a signal proportional to the time that the seed or particle blocks light from the photodetector.

### BRIEF DESCRIPTION OF THE DRAWINGS

The present disclosure is illustrated by way of example, and not by way of limitation, in the figures of the accompanying drawings and in which:

FIG. 1 illustrates a prior art air seeder.

FIG. 2 illustrates an air seeder tower having a vent valve and an actuator for the valve according to one embodiment.

FIG. 3 illustrates a secondary product line having flow sensors according to one embodiment.

FIG. 4A schematically illustrates an embodiment of an electrical control system.

FIG. 4B schematically illustrates another embodiment of an electrical control system.

FIG. 5 illustrates a secondary product line having an optical sensor according to one embodiment.

FIGS. 6A and 7A illustrate a single array embodiment of the particle counter assembly 200A in accordance with one embodiment.

FIGS. 6B and 7B illustrate a double array embodiment of a seed or particle counter assembly 200B in accordance with another embodiment.

FIG. 8 illustrates a sensor (e.g., optical seed or particle sensor, image sensor, camera) for detecting characteristics of seed or particle flow through a product line, secondary product line, or pipe in accordance with one embodiment.

FIG. 9 illustrates a sensor (e.g., optical seed or particle sensor, image sensor) for detecting characteristics of seed or particle flow through a product line, secondary product line, or pipe in accordance with one embodiment.

FIGS. 10A and 10B illustrate dual product type detection in accordance with one embodiment.

FIG. 11 illustrates a flow diagram of one embodiment for a method 1100 of using sensors with alternating light sources to determine characteristics of different product types that are being applied simultaneously during an application pass.

FIG. 12 shows an example of a system 1200 that includes a machine 1202 (e.g., tractor, combine harvester, etc.) and an implement 1240 (e.g., planter, sidedress bar, cultivator, plough, sprayer, spreader, irrigation implement, etc.) in accordance with one embodiment.

FIG. 13 illustrates an air seeder 10 in accordance with one embodiment.

FIG. 14 is a side elevation view of one of a plurality of row units 310 of a row crop planter 300 showing the particle counter system 200 disposed on a seed tube 332 of the row unit 310 for counting the seeds in accordance with an embodiment.

### BRIEF SUMMARY

In one embodiment, an electrical control system comprises at least one sensor that is configured to illuminate multiple light sources with each light source having a different wavelength and to sense one or more products flowing in a product line of an agricultural implement. Processing logic is coupled to the at least one sensor and the processing logic is configured to obtain sensor data from the at least one sensor, to determine response signals for each product when illuminated based on the sensor data, and to analyze the response signals for each product to determine product characteristics including color of each product to distinguish each product.

### DETAILED DESCRIPTION

All references cited herein are hereby incorporated by reference in their entireties. However, in the event of a conflict between a definition in the present disclosure and one in a cited reference, the present disclosure controls.

Agricultural implements including planters, air seeders or other applicators (e.g., strip tool bars) may use optical sensors to measure a number of seeds or particles/second that are being applied to a field for an agricultural application pass. A grower may apply multiple products (e.g., seeds, particles, fertilizers) during an application pass. One or more of the products may be difficult to count and also it may be hard to distinguish between different products. If 1 product runs out or has blockage, the grower will want to be able to identify the problem (e.g., blockage of one of the products, a desired 60/40 split between products A and B is actually a 70/30 split) and product type quickly to resolve the problem.

In one embodiment, an optical sensor positioned on or near a product line is able to illuminate multiple light sources and obtain sensor data (e.g., response signals of the products to indicate reflectance or absorbance spectrum for different products). The sensor data is used to distinguish between different products and identify different characteristics including color of the different products in order to help the grower monitor the application and quickly identify and resolve any potential application problems.

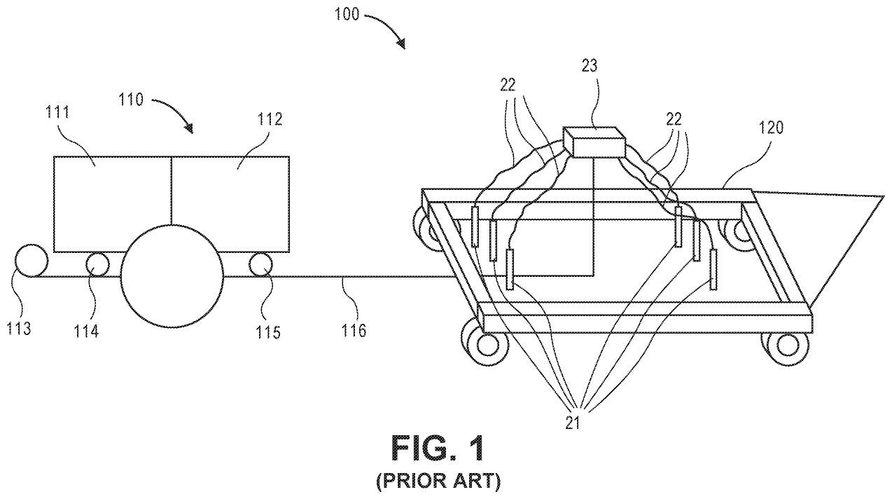

FIG. 1 illustrates a typical air seeder 100. Air seeder 100 includes a cart 110 and frame 120. Cart 110 has hopper 111 and hopper 112 for storing seed and fertilizer, respectively. A main product line 116 is connected to a fan 113 for conveying seed and fertilizer conveyed from meter 114 and meter 115, respectively. Main product line 116 feeds seed and fertilizer to manifold tower 23. Seed and fertilizer are distributed through manifold tower 23 to secondary product lines 22 to openers 21.

While the description below is for control of a manifold tower 123 of one section of an air seeder 100, the same system can be applied to each section.

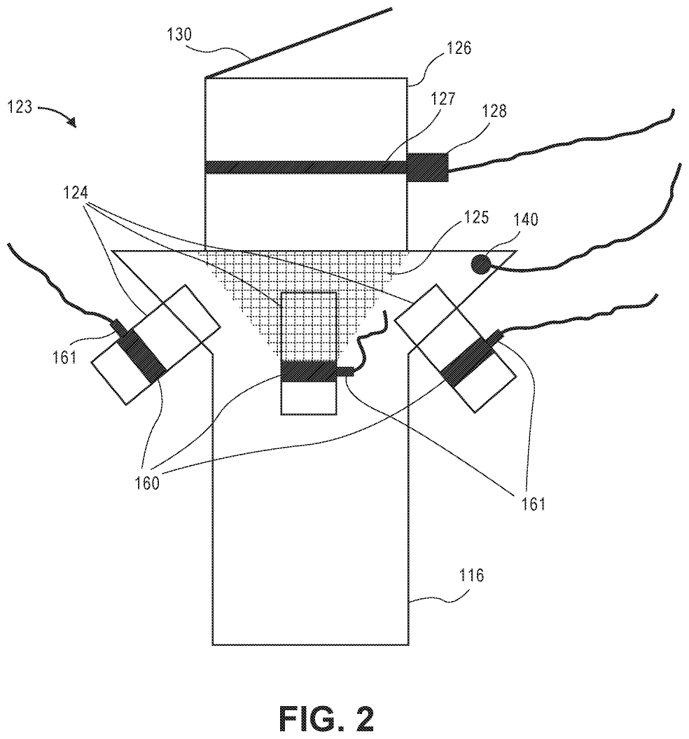

FIG. 2 illustrates manifold tower 123. Manifold tower 123 has main product line 116 providing seed and optionally particles (e.g., fertilizer) in a flow of air. The main product line 116 is connected to a fan 113 (or blower 113) for conveying seed and particles conveyed from seed meters. Seed/particles impact screen 125 has a mesh size to prevent passage of seed and/or particles. Seeds/particles fall into outlets 124 (or exit ports) and feed into secondary product lines 122. Above screen 125 is a tower 126 which contains a valve 127. Valve 127 can be any type of valve that can be actuated. In one embodiment, valve 127 is a butterfly valve. Valve 127 is actuated by actuator 128, which is disposed on tower 126. Actuator 128 is in signal contact with electrical control system 400. Optionally, a lid 130 is pivotably attached to tower 126 to cover tower 126 when no air is flowing. When air is flowing, lid 130 raises by the force of air flowing through tower 126, and when air is not flowing, lid 130 closes tower 126.

In one embodiment, which is illustrated in FIG. 2, manifold tower 123 further includes a pressure sensor 140 disposed in the manifold tower 123. In another embodiment, pressure sensor 140 is disposed in at least one secondary product line 122. Pressure sensor 140 is in signal communication with electrical control system 400. This can provide a closed loop feedback control of valve 127. In another embodiment, electrical control system 400 measures the pressure at pressure sensor 140 in the manifold tower 123 and the pressure sensor 140 in the secondary product line 122 and calculates a difference between each pressure sensor. Electrical control system 400 can control based on the pressure difference.

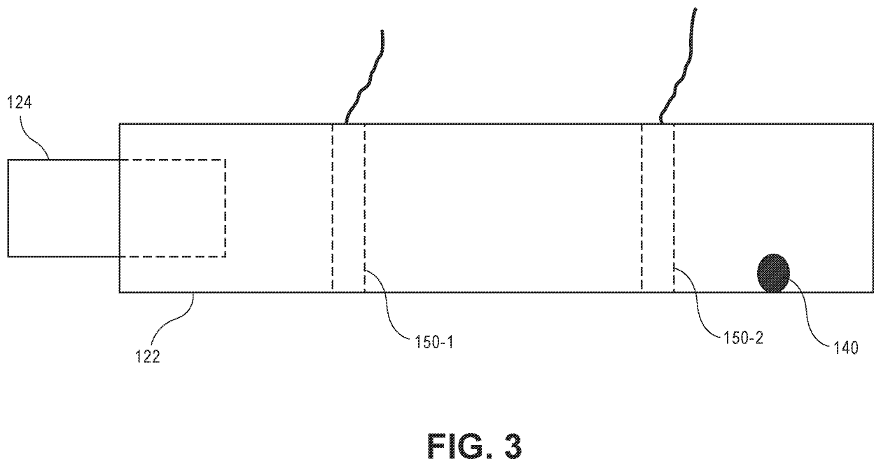

In another embodiment, which is illustrated in FIG. 3, there are a first particle sensor 150-1 and a second particle sensor 150-2 disposed serially within at least one secondary product line 122. First particle sensor 150-1 and second particle sensor 150-2 can be disposed individually or as parts within one unit. First particle sensor 150-1 and second particle sensor 150-2 are spaced at a distance such that a waveform measured at the first particle sensor 150-1 will be duplicated at the second particle sensor 150-2. As seeds travel through an air seeder, they will not flow in a uniform distribution all of the time. In a selected cross section, there can be one, two, three, four, five, or more seeds together. As the seeds travel over a distance, the distribution of seeds in each grouping can expand or condense. Over a short distance, the grouping will remain uniform. Each grouping of seeds will generate a different waveform in a particle sensor. The waveforms from a plurality of groupings will create a pattern in the first particle sensor 150-1. When this pattern is then detected at the second particle sensor 150-2, the time difference between each of these measurements is then divided by the distance between first particle sensor 150-1 and second particle sensor 150-2 to determine the speed of seeds/fertilizer in the secondary product line 122. Using the speed, electrical control system 400 can actuate actuator 128 to change the amount of air exiting tower 126 to change the speed of seed/particles in the secondary product line 122.

An example of a particle sensor is Wavevision Sensor from Precision Planting LLC, and which is described in U.S. Pat. No. 6,208,255. First particle sensor 150-1 and second particle sensor 150-2 are in signal communication with electrical control system 400. This can provide a closed loop feedback control of valve 127.

While both the pressure sensor 140 and the particle sensors 150-1, 150-2 are illustrated, only one is needed for the closed loop feedback control.

In another embodiment that is illustrated in FIG. 2, there can be at least one valve (e.g., valve 160) disposed in each outlet 124 (or exit port) and actuated by actuator 161, which is in signal communication with electrical control system 400. Each actuator 161 (or actuators) can be individually controlled to further regulate flow with at least one valve in each secondary product line 122. The pressure sensor 140, an optical sensor, or particle sensors 150-1, 150-2 in each secondary product line 122 can provide the measurement for controlling each actuator.

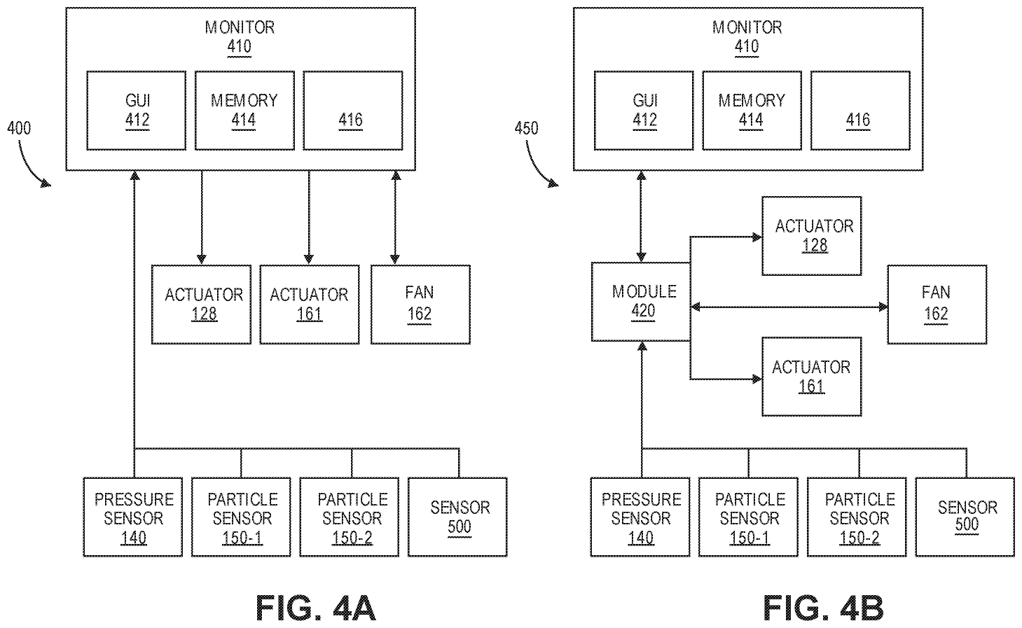

Electrical control system 400 is illustrated schematically in FIG. 4A in accordance with one embodiment. In the electrical control system 400, the monitor 410 is in signal communication with actuator 128, actuator 161, pressure sensor 140, optical sensor 500 (e.g., blockage sensor 500, particle counter assembly 200A, 200B, sensor 800, sensor 900), particle sensors 150-1, 150-2, and fan 162. It should be appreciated that the monitor 410 comprises an electrical controller. Monitor 410 includes processing logic 416 (e.g., a central processing unit (CPU) 416), a memory 414, and optionally a graphical user interface (GUI) 412, which allows a user to view and enter data into the monitor 410. The monitor 410 can be of a type disclosed in U.S. Pat. No. 8,386,137. For example, monitor 410 can be a planter monitor system that includes a visual display and user interface, preferably a touch screen graphic user interface (GUI). The touchscreen GUI is preferably supported within a housing which also houses a microprocessor, memory and other applicable hardware and software for receiving, storing, processing, communicating, displaying and performing various features and functions. The planter monitor system preferably cooperates and/or interfaces with various external devices and sensors.

An alternative electrical control system 450 is illustrated in FIG. 4B, which includes a module 420. Module 420 receives signals from pressure sensor 140, optical sensor 500 (e.g., blockage sensor 500, particle counter assembly 200A, 200B, sensor 800, sensor 900), particle sensors 150-1, 150-2, and fan 162, which can be provided to monitor 310 to output on GUI 412. Module 420 can also provide control signals to actuator 128, actuator 161 and fan 162, which can be based on operator input into monitor 410.

In operation of the closed loop feedback control, monitor 410 receives a signal from the pressure sensor, optical sensor 500, and/or particle sensors 150-1, 150-2. The monitor 410 uses the pressure signal, optical sensor signal, and/or the particle signal to set a fan speed of fan 162 to regulate air speed of particles or seed in product lines. The monitor 410 may also use the pressure signal, optical sensor signal, and/or the particle signal to set selected position of actuator 128 to control valve 127 to regulate the amount of air leaving tower 126. Monitor 410 sends a signal to actuator 128 to effect this change. This in turn controls the amount of air flow in secondary product lines 122 to convey seeds/fertilizer to the trench with the appropriate force and/or speed to place the seeds/fertilizer in the trench without having the seeds/fertilizer bounce out of the trench. The monitor 410 may also use the optical sensor signal having responses from each product to determine characteristics of products in a product line including color and a ratio of the products (e.g., ratio of 2 products, ratio of 3 products, etc.).

In one example, the module 420 is located on an implement or on a tractor. The module 420 receives sensor data from the sensors that are located on an implement. The module processes the sensor data to perform operations of methods discussed herein or the module sends the sensor data to processing logic to perform operations of methods discussed herein.

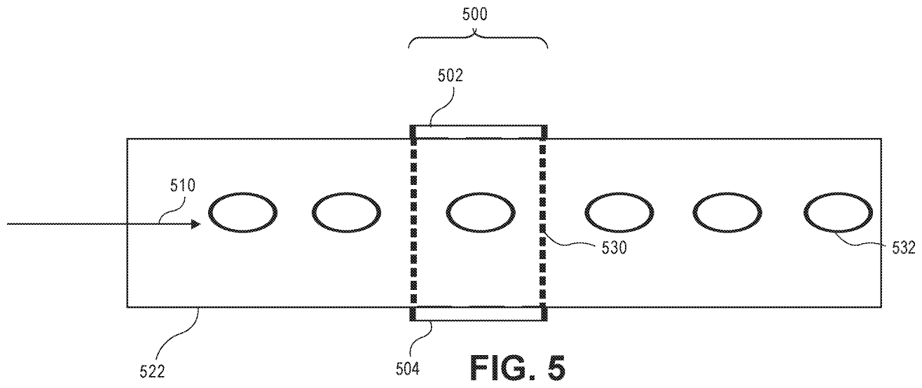

FIG. 5 illustrates a sensor (e.g., optical seed or particle sensor, image sensor) for detecting flow through a product line, secondary product line, or pipe in accordance with one embodiment. The sensor 500 is positioned on a line 522 (e.g., secondary product line) or pipe 522 or in close proximity to the line 522 or pipe 522. The sensor (or optical sensors) includes a transmitter 504 to transmit light 530. A receiver 502 receives this light 530 if no blockage. Flow of seed or particles 532 in a direction 510 through this light 530 (e.g., infrared light) causes a temporary blockage of the received light.

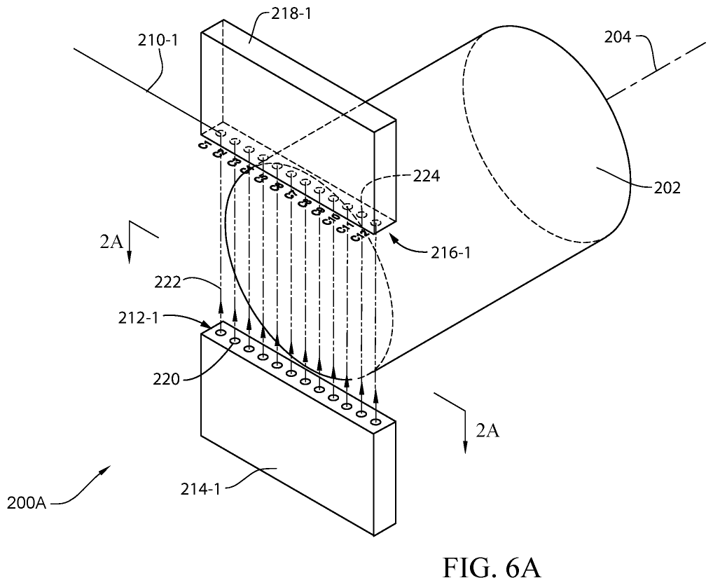

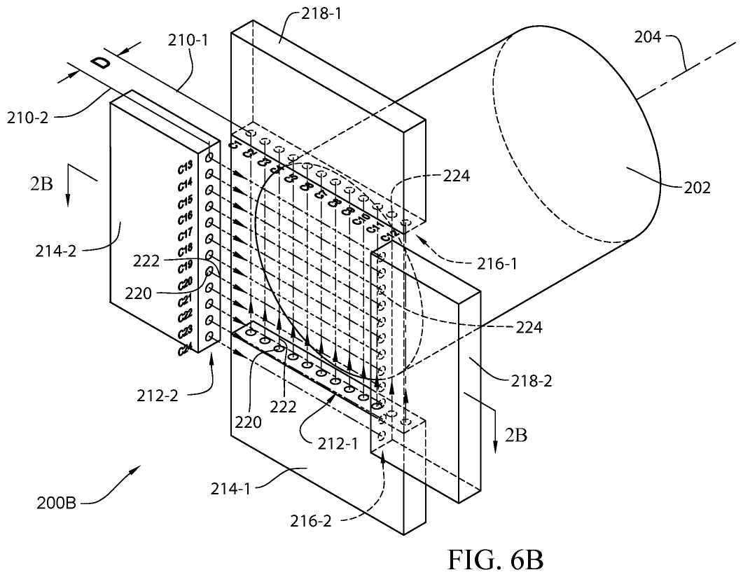

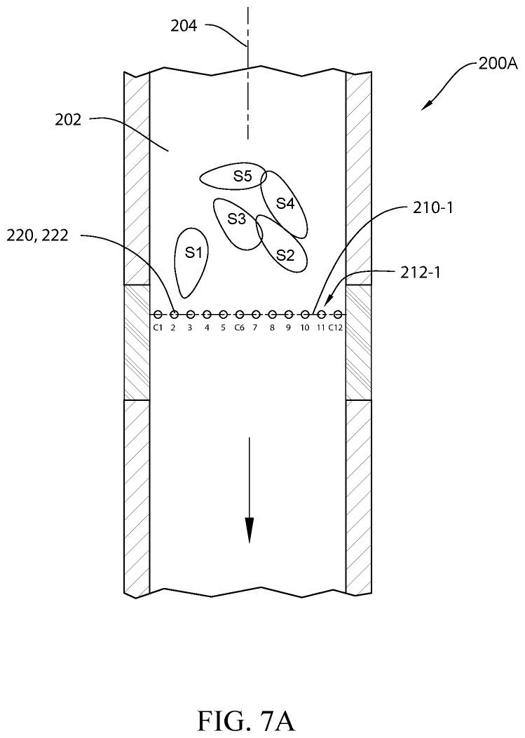

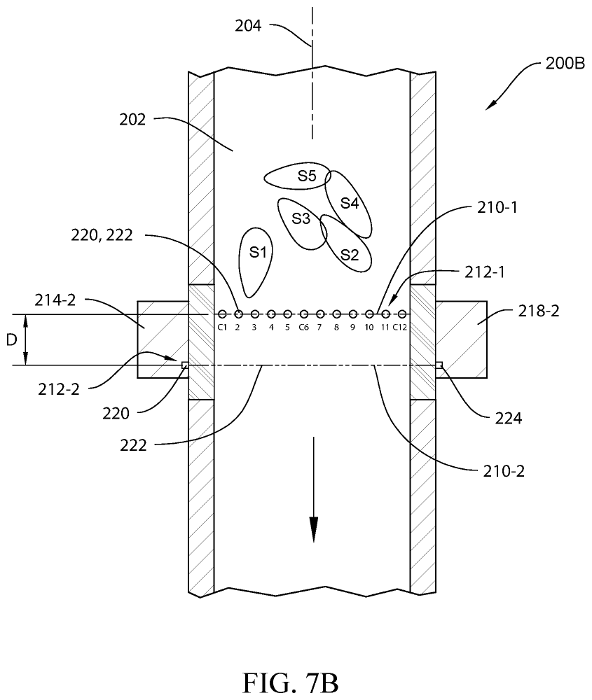

In a single array embodiment of the particle counter assembly 200A illustrated in FIGS. 6A and 7A, a single light plane 210-1 is generated across the passageway 202. The single light plane 210-1 is generated by an LED emitter array 212-1 disposed within an emitter housing 214-1 located on one side of the passageway 202. On the opposite side of the passageway 202 and directly opposing the LED emitter array 212-1 is a corresponding receiver array 216-1 disposed within a receiver housing 218-1.

In a double array embodiment of a seed or particle counter assembly 200B illustrated in FIGS. 6B and 7B, two distinct light planes 210-1, 210-2 are generated across the passageway 202, with the light planes 210-1, 210-2 longitudinally offset from one another along the passageway 202 by a distance “D” such that a particle will sequentially pass through the first light plane 210-1 and then through the second light plane 210-2. Each light plane 210-1, 210-2 is generated by a respective LED emitter array 212-1, 212-2, with each array disposed within a respective emitter housing 214-1, 214-2 located on two sides of the passageway 202 oriented 90 degrees with respect to one another around the longitudinal axis 204 of the passageway 202 in order to detect the passage of particles in three dimensions. On the opposite sides of the passageway 202 and directly opposing each of the respective LED arrays 212-1, 212-2 is a corresponding receiver array 216-1, 216-2, with each receiver array 216-1, 216-2 disposed within a respective receiver housing 218-1, 218-2.

In either of the array embodiments 200A, 200B, the LED arrays 212-1, 212-2, as applicable, comprise a row of closely spaced LED emitters 220, each of which produces a light beam or light channel 222 across the width or diameter of the passageway 202. The respective receiver arrays 216-1, 216-2, as applicable, comprise a corresponding number of closely spaced photodiode receivers 224 which receive the light beams or light channels 222 of the opposing LED emitter 220. In one embodiment, the photodiode receivers 224 and LED emitters 220 are directly aligned with each other such that a line between them is perpendicular to each of the photodiode receivers 224 and the LED emitters 220. In other embodiments, the lines are not perpendicular. In both embodiments 200A, 200B, the first LED array 212-1 is shown as having 12 LED emitters 220 producing light beams or light channels 222 (designated Cl-Cl 2) extending across the width or diameter of the passageway 202.

In the double array embodiment 200B, the second LED array 212-2 is also shown as having 12 LED emitters producing light beams or light channels 222 (designated C13-C24) extending across the width of the passageway 202 perpendicular to the light channels Cl-Cl 2 of the first LED array 212-1. Each corresponding receiver array 216-1, 216-2, as applicable, is shown as having 12 corresponding photodiodes 224. It should be appreciated that more or fewer LED emitters and photodiode receivers with greater or tighter spacings may be used. It should also be appreciated that LED's with wider or tighter beam angles and light intensities may be used depending on the particular application, including the width or diameter of the passageway 202 and the sizes of the particles to be detected passing through the passageway 202, and various other factors recognized by those of skill in the art. By way of example only, in applications for detecting seeds passing through distribution lines 58 of an air seeder 10, suitable LED emitters may be SM1206NHC-IL LED emitters available from Bivar, Inc. having beam angles of 30 degrees with the LED emitters 220 spaced at 0.08 inches (0.2 cm), and suitable photodiodes 224 may be TEMD7000X01 photodiodes available from Vishay Intertechnology, Inc. which may be spaced at 0.08 inches (0.2 cm). In the double array embodiment 200B, a suitable longitudinal offset distance “D” between the light planes 210-1, 210-2 may be 0.125 inches (0.32 cm), between 0.05 to 1 inch (0.13 to 2.5 cm), or between 0.1 to 0.5 inches (0.2 cm to 1.3 cm).

FIGS. 7A and 7B are intended to represent a snapshot of a group of seeds S1-S5 passing through a passageway 202, such as the distribution line 58 of an air seeder 10. It should be appreciated that in an air seeder application, the seeds are carried in an airstream through the distribution lines 58 at a relatively high rate of speed and in a substantially continuous stream (particularly when planting small seeds at high application rates such as canola, flax, millet, oats, wheat, rye, barley, etc.), so the snap shot illustration of the group of seeds in FIG. 7A or 7B is provided for simplicity for explaining the scan of the signals generated by that group of seeds passing through the single light plane 210-1 or the double light planes 210-1, 210-2 and the other processes carried out to analyze the signals for purposes of counting and characterizing the seeds. While the following description refers to seeds for purposes of explaining the process in an air seeder or in a singulating planter application, it should be appreciated that the term “seeds” are used as an example only and therefore the term “seeds” should be understood as being interchangeable with the term particle. Additional description of single and double array embodiments is provided in International Patent Publication No. WO 2020/194150, which is incorporated by reference herein.

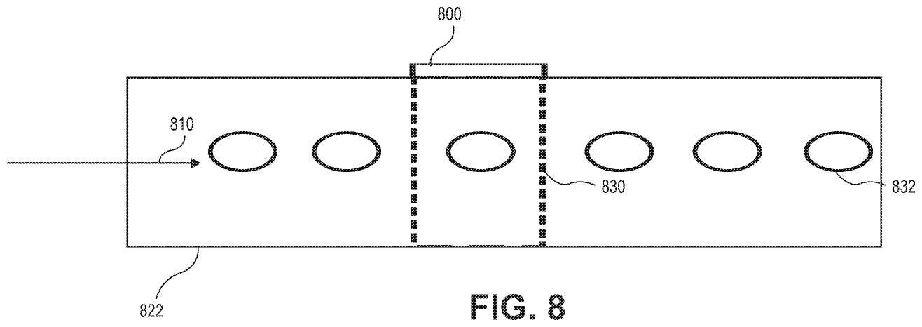

FIG. 8 illustrates a sensor (e.g., optical seed or particle sensor, image sensor, camera) for detecting characteristics of seed or particle flow through a product line, secondary product line, or pipe in accordance with one embodiment. The sensor 800 is positioned on a line 822 (e.g., secondary product line) or pipe 822 or in close proximity to the line 822 or pipe 822. The sensor (or optical sensors) includes light sources (e.g., green wavelength light, infrared light, etc.) that can be intermittently flashed to emit light and an image sensor to capture images of seeds or particles 832 that pass through a region 830 in a direction 810 while the light sources are emitting light.

In one embodiment, the sensor 800 is a high speed camera and image annotation is performed to identify seeds or particles in a flow stream that pass through the region 830. In one example, the camera has low resolution and a RGB Bayer filter for visible color spectrum. Color thresholds can be designed to distinguish different products (e.g., pink seed treatment, white urea particle, brown phosphorus particle, etc.) and provide a ratio of products being applied during an application pass. Images of a stream of seeds and/or particles are analyzed based on color of the seeds and/or particles using machine learning or a neural network can be trained to identify unique seeds and particles. A treatment to a seed or particle may affect color, reflectance, and absorbance characteristics of the seed or particle.

In another example, images are captured at a high frame rate, but only pulled and analyzed for a sample at some longer time period. To obtain a more complete understanding of what is happening in between frames, the sensor captures a second image with a long exposure time to visualize the seeds and/or particles that have passed thru the region 830 over an extended period of time.

This sensor 800 is capable of obtaining sensor data that is used to distinguish between different particles like seed and fertilizer based on comparing a relative difference of response signals that are generated based on emitting light from different light sources having different wavelengths to identify different types of unique products. In one example, a first light source has a wavelength of approximately 550 to 600 nm and a second light source is infrared having a wavelength of 780 nm to 1 mm. In one example, the infrared wavelength is approximately 925 to 975 nm. Seed and fertilizer particles respond proportionally different at 2 different wavelengths and thus wavelengths for the sensor 800 are selected based on reflectance or absorbance of each product to cause a best contrast during image analysis.

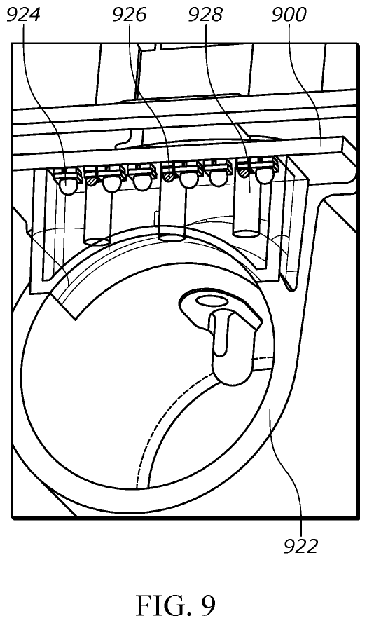

FIG. 9 illustrates a sensor (e.g., optical seed or particle sensor, image sensor) for detecting characteristics of seed or particle flow through a product line, secondary product line, or pipe in accordance with one embodiment. The sensor 900 is positioned on a line 922 (e.g., secondary product line) or pipe 922 or in close proximity to the line 922 or pipe 922. The sensor (or optical sensors) includes light sources (e.g., green wavelength light source 924, infrared light source 926, etc.) that can be intermittently or alternatively flashed to emit light and an image sensor (e.g., photodetector 928) capture images of seeds or particles that pass through the line or pipe while the light sources are emitting light.

This sensor 900 generates sensor data that is used to distinguish between different particles like seed and fertilizer based on comparing a relative difference in response signals of reflectance or absorbance data based on alternating between different wavelengths to identify different types of unique products. In one example, a first light source 924 has a wavelength of approximately 550 to 600 nm and a second light source 926 is infrared having a wavelength of 780 nm to 1 mm. In one example, the infrared wavelength is approximately 925 to 975 nm.

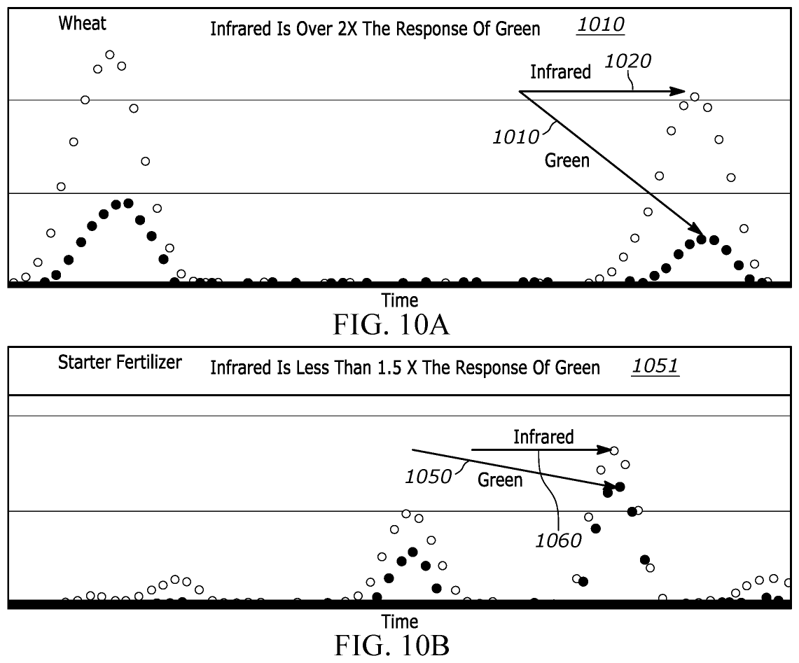

FIGS. 10A and 10B illustrate dual product type detection in accordance with one embodiment. FIG. 10A illustrates a diagram 1000 of response signals 1010 and 1020 captured by the sensor for wheat while alternating pulsing of green and infrared light sources. The wheat while passing through the line or pipe reflects the alternating pulsing of green and infrared lights source to generate an infrared response signal 1020 and a green response signal 1010. The response signal 1020 has a magnitude that is greater than twice a magnitude of the response signal 1010.

FIG. 10B illustrates a diagram 1051 of response signals 1050 and 1060 captured by the sensor for fertilizer while alternating pulsing of green and infrared light sources. The fertilizer while passing through the line or pipe reflects the alternating pulsing of green and infrared lights source to generate an infrared response signal 1060 and a green response signal 1050. The response signal 1060 has a magnitude that is less than 1.5 times a magnitude of the response signal 1050.

The wheat and fertilizer particles respond proportionally different at 2 different wavelengths and thus wavelengths for the sensor 900 are selected to cause a difference in response signals and best contrast during image analysis between different product types being applied.

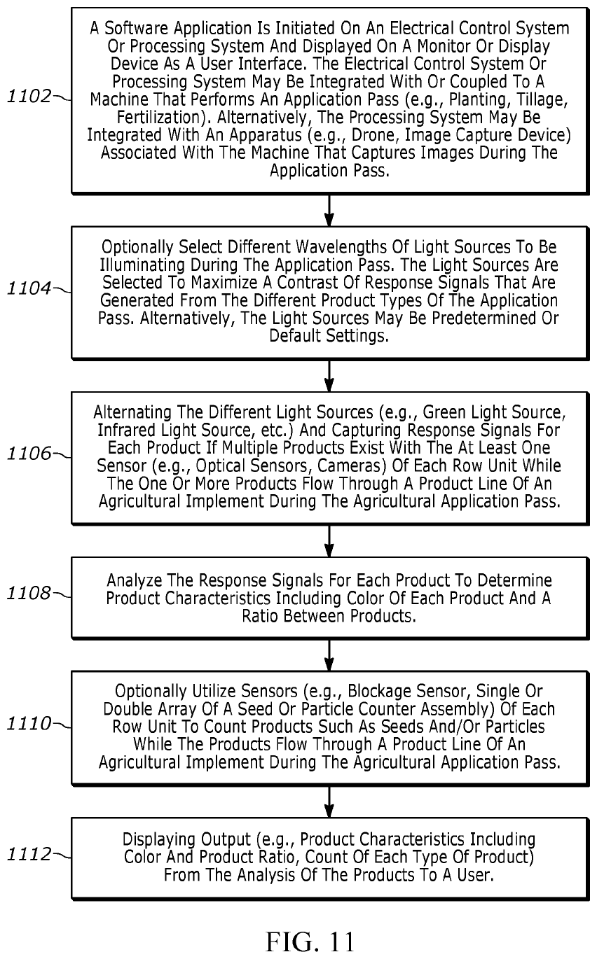

FIG. 11 illustrates a flow diagram of one embodiment for a method 1100 of using sensors with alternating light sources to determine characteristics of different product types that are being applied simultaneously during an application pass. The method 1100 is performed by processing logic that may comprise hardware (circuitry, dedicated logic, etc.), software (such as is run on a general purpose computer system or a dedicated machine or a device), or a combination of both. In one embodiment, the method 1100 is performed by processing logic (e.g., processing logic 1226, processing logic 416) of an electrical control system (e.g., electrical control system 400, electrical control system 450, monitor 410 having CPU 416, module 420, etc). The electrical control system or processing system (e.g., processing system 1220, 1262) executes instructions of a software application or program with processing logic. The software application or program can be initiated by the electronic control system or processing system. In one example, a monitor or display device receives user input and provides a customized display for operations of the method 1100.

At operation 1102, a software application is initiated on an electrical control system or processing system and displayed on a monitor or display device as a user interface. The electrical control system or processing system may be integrated with or coupled to a machine that performs an application pass (e.g., planting, tillage, fertilization). Alternatively, the processing system may be integrated with an apparatus (e.g., drone, image capture device) associated with the machine that captures images during the application pass.

An agricultural application pass (e.g., planting, fertilization, etc.) is initiated and performed with an implement. At operation 1104, the method optionally selects different wavelengths of light sources to be illuminating during the application pass. The light sources are selected to maximize a contrast of response signals that are generated from the different product types of the application pass if multiple products are being applied during the application pass. Alternatively, the light sources may be predetermined or default settings.

At operation 1106, the method includes alternating the different light sources (e.g., green light source, infrared light source, etc.) and capturing response signals for each product, if multiple products exist, with the at least one sensor (e.g., optical sensors, cameras) of each row unit while the one or more products flow through a product line of an agricultural implement during the agricultural application pass. This line supplies the one or more products to an agricultural field.

In one example, at operation 1108, the method includes analyzing the response signals for each product to determine product characteristics including color of each product and a ratio between products if multiple products are being applied during the application pass. For example, a ratio of 60/40 for two product can indicate detection of 60% of product A and 40% of product B from analyzing the response signals.

At operation 1110, the method can optionally include utilizing sensors (e.g., blockage sensor, single or double array of a seed or particle counter assembly) of each row unit to count products such as seeds and/or particles while the products flow through a product line of an agricultural implement during the agricultural application pass.

At operation 1112, the method including displaying output (e.g., product characteristics including color and product ratio, count of each type of product) from the analysis of the products to a user. If the output is provided in real time, then the user can adjust parameters during the application pass or take corrective action if a problem exists during the application pass. The method can automatically adjust a parameter (e.g., application rate, product ratio) if desired by the user. In one example, a user (e.g., operator, farmer, grower) can decide whether to adjust a product ratio based on the product ratio that is determined during the application pass.

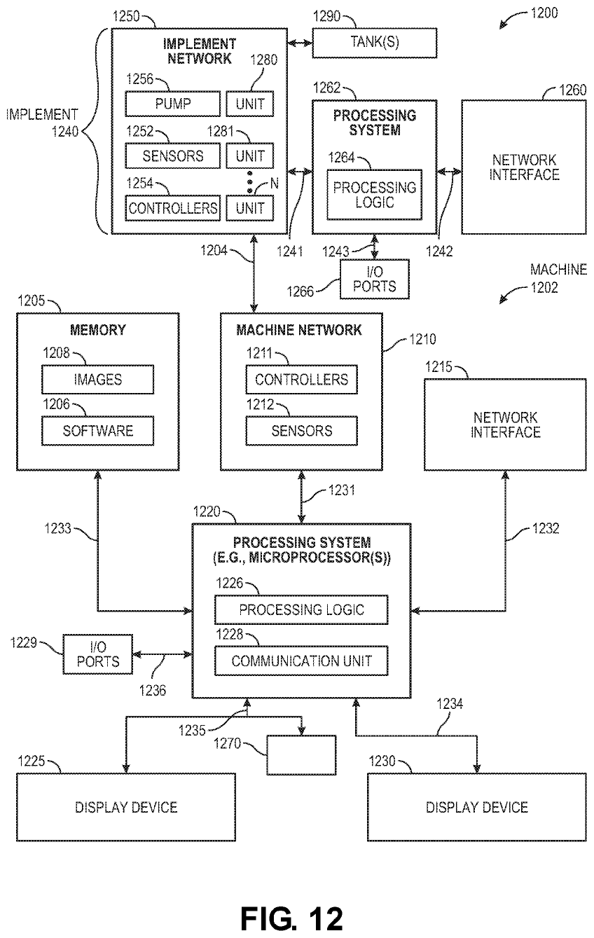

FIG. 12 shows an example of a system 1200 that includes a machine 1202 (e.g., tractor, combine harvester, etc.) and an implement 1240 (e.g., planter, sidedress bar, cultivator, plough, sprayer, spreader, irrigation implement, etc.) in accordance with one embodiment. The machine 1202 includes a processing system 1220, memory 1205, machine network 1210 (e.g., a controller area network (CAN) serial bus protocol network, an ISOBUS network, etc.), and a network interface 1215 for communicating with other systems or devices including the implement 1240. The machine network 1210 includes sensors 1212 (e.g., speed sensors, optical sensors, sensors 500, 800, 900, particle counter assembly 200A, 200B), controllers 1211 (e.g., GPS receiver, radar unit) for controlling and monitoring operations of the machine or implement. The network interface 1215 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 1215 may be integrated with the machine network 1210 or separate from the machine network 1210 as illustrated in FIG. 9. The I/O ports 1229 (e.g., diagnostic/on board diagnostic (OBD) port) enable communication with another data processing system or device (e.g., display devices, sensors, etc.).

In one example, the machine performs operations of a tractor that is coupled to an implement for planting applications and seed or particle sensing during an application. The planting data and seed/particle data for each row unit of the implement can be associated with locational data at time of application to have a better understanding of the planting and seed/particle characteristics for each row and region of a field. Data associated with the planting applications and seed/particle characteristics can be displayed on at least one of the display devices 1225 and 1230. The display devices can be integrated with other components (e.g., processing system 1220, memory 1205, etc.) to form the monitor 410.

The processing system 1220 may include one or more microprocessors, processors, a system on a chip (integrated circuit), or one or more microcontrollers. The processing system includes processing logic 1226 for executing software instructions of one or more programs and a communication unit 1228 (e.g., transmitter, transceiver) for transmitting and receiving communications from the machine via machine network 1210 or network interface 1215 or implement via implement network 1250 or network interface 1260. The communication unit 1228 may be integrated with the processing system or separate from the processing system. In one embodiment, the communication unit 1228 is in data communication with the machine network 1210 and implement network 1250 via a diagnostic/OBD port of the I/O ports 1229.

Processing logic 1226 including one or more processors or processing units may process the communications received from the communication unit 1228 including agricultural data (e.g., GPS data, planting application data, soil characteristics, any data sensed from sensors of the implement 1240 and machine 1202, etc.). The system 1200 includes memory 1205 for storing data and programs for execution (software 1206) by the processing system. The memory 1205 can store, for example, software components such as planting application software or seed/particle software for analysis of characteristics of seed/particle and planting applications for performing operations of the present disclosure, or any other software application or module, images (e.g., captured images of crops, seed, soil, furrow, soil clods, row units, etc.), alerts, maps, etc. The memory 1205 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1220 communicates bi-directionally with memory 1205, machine network 1210, network interface 1215, display device 1230, display device 1225, and I/O ports 1229 via communication links 1231-1236, respectively. The processing system 1220 can be integrated with the memory 1205 or separate from the memory 1205.

Display devices 1225 and 1230 can provide visual user interfaces for a user or operator. The display devices may include display controllers. In one embodiment, the display device 1225 is a portable tablet device or computing device with a touchscreen that displays data (e.g., planting application data, captured images, localized view map layer, high definition field maps of different measured seed/particle data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, measured seed/particle data, response signals of products during illumination of light sources, relative product speed data, as-applied fluid application data, as-planted or as-harvested data, yield data, seed germination data, seed environment data, controlling a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation implement, etc.) includes an implement network 1250, a processing system 1262, a network interface 1260, and optional input/output ports 1266 for communicating with other systems or devices including the machine 1202. The implement network 1250 (e.g., a controller area network (CAN) serial bus protocol network, an ISOBUS network, etc.) includes a pump 1256 for pumping fluid from a storage tank(s) 1290 to application units 1280, 1281, . . . . N of the implement, sensors 1252 (e.g., radar, electroconductivity, electromagnetic, a force probe, speed sensors, seed/particle sensors for detecting passage and characteristics of seed/particle, sensors for detecting characteristics of soil or a trench including a plurality of soil layers differing by density, a depth of a transition from a first soil layer to a second soil layer based on density of each layer, a magnitude of a density layer difference between soil layers, a rate of change of soil density across a depth of soil, soil density variability, soil surface roughness, residue mat thickness, a density at a soil layer, soil temperature, seed presence, seed spacing, percentage of seeds firmed, and soil residue presence, at least one optical sensor to sense at least one of soil organic matter, soil moisture, soil texture, and soil cation-exchange capacity (CEC), downforce sensors, actuator valves, moisture sensors or flow sensors for a combine, speed sensors for the machine, seed force sensors for a planter, fluid application sensors for a sprayer, or vacuum, lift, lower sensors for an implement, flow sensors, etc.), controllers 1254 (e.g., GPS receiver), and the processing system 1262 for controlling and monitoring operations of the implement. The pump controls and monitors the application of the fluid to crops or soil as applied by the implement. The fluid application can be applied at any stage of crop development including within a planting trench upon planting of seeds, adjacent to a planting trench in a separate trench, or in a region that is nearby to the planting region (e.g., between rows of corn or soybeans) having seeds or crop growth.

For example, the controllers may include processors in communication with a plurality of seed sensors. The processors are configured to process data (e.g., fluid application data, seed sensor data, data for distinguishing between different product types, soil data, furrow or trench data) and transmit processed data to the processing system 1262 or 1220. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 1260 can be a GPS transceiver, a WLAN transceiver (e.g., WiFi), an infrared transceiver, a Bluetooth transceiver, Ethernet, or other interfaces from communications with other devices and systems including the machine 1202. The network interface 1260 may be integrated with the implement network 1250 or separate from the implement network 1250 as illustrated in FIG. 12.

The processing system 1262 communicates bi-directionally with the implement network 1250, network interface 1260, and I/O ports 1266 via communication links 1241-1243, respectively.

The implement communicates with the machine via wired and possibly also wireless bi-directional communications 1204. The implement network 1250 may communicate directly with the machine network 1210 or via the network interfaces 1215 and 1260. The implement may also by physically coupled to the machine for agricultural operations (e.g., seed/particle sensing, planting, harvesting, spraying, etc.).

The memory 1205 may be a machine-accessible non-transitory medium on which is stored one or more sets of instructions (e.g., software 1206) embodying any one or more of the methodologies or functions described herein. The software 1206 may also reside, completely or at least partially, within the memory 1205 and/or within the processing system 1220 during execution thereof by the system 1200, the memory and the processing system also constituting machine-accessible storage media. The software 1206 may further be transmitted or received over a network via the network interface 1215.

In one embodiment, a machine-accessible non-transitory medium (e.g., memory 1205) contains executable computer program instructions which when executed by a data processing system cause the system to perform operations or methods of the present disclosure. While the machine-accessible non-transitory medium (e.g., memory 1205) is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present disclosure. The term “machine-accessible non-transitory medium” shall accordingly be taken to include, but not be limited to, solid-state memories, optical and magnetic media, and carrier wave signals.

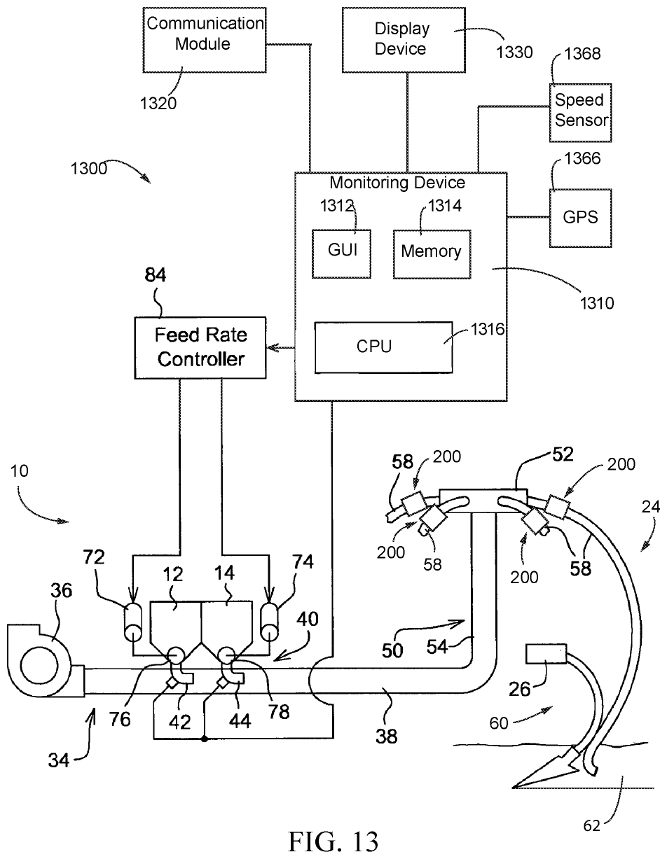

Referring to FIG. 13, the air seeder 10 includes an air distribution system 34 such as disclosed in U.S. Pat. No. 6,213,690, which is incorporated herein in its entirety by reference. The air seeder 10 includes an air cart and a ground engaging implement 24. The air distribution system 34 includes a fan 36 for directing air through a main conduit 38. A metering mechanism 40 is located at the bottom of each tank 12, 14 for delivering metered amounts of seed, fertilizer or other granular products through product passages 42, 44 from the respective tanks 12, 14 into main conduits 38 (only one main conduit 38 is shown in FIG. 13). The product metered by the metering mechanism 40 into the main conduits 38 is carried by the air stream to a downstream distribution tower 50. Typically, there will be one tower 50 for each main conduit 38. Additionally, separate main conduits 38 may be provided for each of the respective tanks, such that different products within those respective tanks 12, 14 may be distributed separately to a respective tower 50 for delivery via separate distribution lines 58 to individual row units 60 as described below. Alternatively, the product from the respective tanks 12, 14 may be combined in a common main conduit 38 as shown in FIG. 13 for distribution together. While two tanks 12, 14 are shown with the associated metering mechanisms 40 and main conduits 38, it should be appreciated that any number of tanks, metering mechanisms 40 and main conduits 38, may be provided on the air seeder 10 as desired.

The metering mechanism 40 may be a volumetric metering mechanism, but may be any other suitable metering mechanism that is known in the art or hereinafter developed. As identified above, the product passages 42, 44 direct the product from the metering mechanism 40 into the main conduits 38 which carry the product in the air stream to the downstream distribution towers 50. Each tower 50 includes an uppermost distributing bead 52 located at the uppermost end of a vertical distribution tube 54. The head 52 evenly divides the flow of product into a number of distribution lines 58. Each distribution line 58 delivers product to a downstream row unit 60. The row unit 60 opens a furrow 62 in the soil surface. The distribution line deposits the product into the furrow 62 and a trailing firming or closing wheel firms the soil over the deposited product. Although the row unit 60 shown in FIG. 13 shows a shank with a point for opening the furrow 62, and shows only one distribution line 58 to each row unit 60, it should be appreciated that the row unit 60 may be a single pass, double-shoot row unit utilizing a cutting disc and boot with dual distribution lines 58 for delivering seed and fertilizer to the soil, such as disclosed in U.S. Pat. Nos. 8,275,525, 9,826,667 and 9,968,030, each of which is incorporated herein in its entirety by reference, and which are commercially embodied in the Case 500 Series air seeder.

Continuing to refer to FIG. 13, the metering mechanisms 40 include variable speed meter drives 72, 74 connected to respective product meters 76, 78 located in the bottom of the respective tanks 12, 14. As the drives 72, 74 rotate the respective meters 76, 78, the product from the respective tanks 12, 14 is delivered via the respective product passages 42, 44 into the main conduit 38 which, in turn, conveys the product to the distribution tower 50. A feed rate controller 84 is connected to the variable speed meter drives 72, 74.

The feed rate controller 84 is in signal communication with the controller 1310 of a monitoring system 1300. The controller 1310 may include a GUI 1312, memory 1314, and processing logic 1316 (e.g., CPU 1316). In addition to the controller 1310 running a software program to perform each of the processes or methods described above, the controller 1310 is also in communication with a speed sensor 1368 which detects the ground speed of the air seeder 10. The controller 1310 controls the feed rate controller 84 to adjust the meter drive speeds to maintain a selected product feed rate with changing ground speed. In an alternative embodiment, the feed rate controller 84 may be coupled so as to be ground driven through a transmission with an output ratio that is adjustable from the cab of the tractor. The controller 1310 is also in communication with the GPS receiver 1366. The controller 1310 controls the feed rate controller 84 to adjust metering rates depending upon the air seeder's location within the field. As discussed below, the monitoring system 1300 includes an input device, such as graphical user interface (GUI) 1312, to allow the operator to enter a desired product feed rate such as pounds per acre or seeds per acre, etc.

### Singulating Row Crop Planter

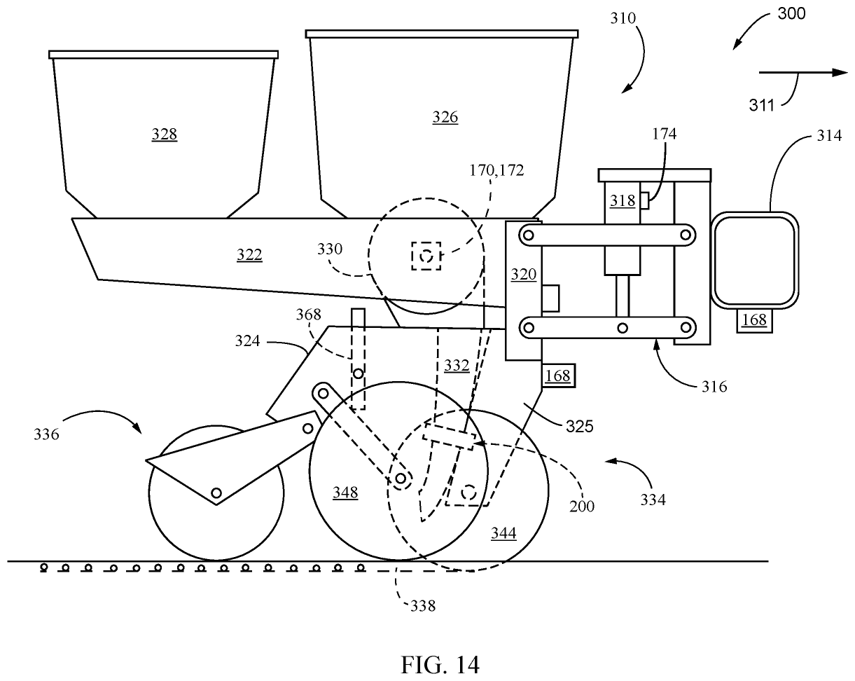

FIG. 14 is a side elevation view of one of a plurality of row units 310 of a row crop planter 300 showing the particle counter system 200 disposed on a seed tube 332 of the row unit 310 for counting the seeds as they fall by gravity through the seed tube 332. Each row unit 310 is supported from the toolbar 314 by a parallel linkage 316 which permits each row unit to move vertically independently of the toolbar and the other spaced row units in order to accommodate changes in terrain or upon the row unit encountering a rock or other obstruction as the planter is drawn through the field. Each row unit 310 may include a front mounting bracket 320 to which is mounted a hopper support beam 322 and a subframe 324. The hopper support beam 322 supports a seed hopper 326 and a fertilizer hopper 328 as well as operably supporting a seed meter 330 and a seed tube 332. The subframe 324 includes a downwardly extending shank 325 which operably supports a furrow opening assembly 334. A furrow closing assembly 336 is operably supported by a rearward end of the subframe 324. The furrow opening assembly 334 may include one or more furrow opening discs 344 operably supported from the shank 325. The furrow opening assembly 334 may include one or more gauge wheels 348 operably supported from the subframe 324 by pivotal gauge wheel arms A depth adjuster 368 is selectively positionable to vary the depth of the furrow opening discs 344 with respect to the gauge wheels 348 in order to vary the depth of the furrow formed by the furrow opening discs.

A ride quality sensor, which may be an accelerometer, may be mounted to the row unit 300 and disposed to measure the vertical velocity and acceleration of the row unit 310. Speed sensors 168, such as radar speed sensors or GPS speed sensors, may be mounted to the toolbar 314 or to the row unit 300. A downforce actuator 318, such as an air bag, hydraulic or pneumatic cylinder or the like, acts on the parallel linkage 316 to exert a downforce on the row unit 300. A downforce valve 174, such as an electrically operated servo valve, may control the amount of downforce applied by the downforce actuator 318.

In operation, as the planter 300 advances in the forward direction of travel as indicated by arrow 311, the furrow opening assembly 334 cuts a furrow 338 into the soil surface. The seed hopper 326, which holds the seeds to be planted, communicates a constant supply of seed to the seed meter 330. In an alternative embodiment the singulating planter 300 may be a central-fill planter including a frame-mounted bulk hopper as is known in the art; in such embodiments the seed hopper 326 may comprise a small auxiliary hopper in seed communication with the bulk hopper. The seed meter 330 is selectively engaged to the drive 172 via the clutch 170 such that individual seeds are metered and discharged into the seed tube 332 at regularly spaced intervals based on the seed population desired and the speed at which the planter 300 is drawn through the field. The drive 172 and clutch 170 may be of the types disclosed in U.S. Pat. No. 8,307,771 incorporated herein in its entirety by reference. In other embodiments, the clutch 170 is omitted and the drives 172 comprise electric drives such as those disclosed in Applicant's International Publication No. WO2017/011355, incorporated herein in its entirety by reference. The particle sensor assembly 200 is supported by the seed tube 332 and detects the passage of seeds through the seed tube 332. The seed drops from the end of the seed tube 332 into the furrow 338 and the seeds are covered with soil by the closing wheel assembly 336. As in the air seeder embodiment, in the singulating planter embodiment 300, the display device 1330, communication module 1320, and controller 1310 may be mounted in a cab of the tractor drawing the singulating planter 300 through the field. One or more speed sensors 168, such as a ball-effect wheel speed sensor or a radar speed sensor, may also be mounted to the tractor.

Any of the following examples can be combined into a single embodiment or these examples can be separate embodiments.

In one example of a first embodiment, a electrical control system comprises at least one sensor that is configured to illuminate multiple light sources with each light source having a different wavelength and to sense one or more products flowing in a product line of an agricultural implement. Processing logic is coupled to the at least one sensor and the processing logic is configured to obtain sensor data from the at least one sensor, to determine response signals for each product when illuminated based on the sensor data, and to analyze the response signals for each product to determine product characteristics including color of each product to distinguish each product.

In one example of a second embodiment, an electrical control system comprises at least one sensor that is configured to alternate illumination of multiple light sources with each light source having a different wavelength while one or more products flow in a product line of an agricultural implement, a module to receive sensor data from the at least one sensor, and processing logic coupled to the module. The processing logic is configured to obtain the sensor data including images of the products flowing in the product line, to determine color thresholds for analyzing the images of the products, and to determine product characteristics including color of each product to distinguish each product based on the images of the products.

In one example of a third embodiment, a computer implemented method comprises alternating illuminating of different light sources with each light source having a different wavelength for at least one sensor on an agricultural implement while products flow through a product line during an application pass of the agricultural implement, capturing sensor data including response signals for each product while the products flow through the product line of the agricultural implement and analyzing the response signals for each product to determine product characteristics including color of each product to distinguish each product.

### Examples

The following are non-limiting examples.

Example 1—An electrical control system comprising: at least one sensor that is configured to illuminate multiple light sources with each light source having a different wavelength and to sense one or more products flowing in a product line of an agricultural implement; and processing logic coupled to the at least one sensor, the processing logic is configured to obtain sensor data from the at least one sensor, to determine response signals for each product based on the sensor data, and to analyze the response signals for each product to determine product characteristics including color of each product to distinguish each product.

Example 2—the electrical control system of Example 1, wherein the product characteristics comprise a ratio of seeds or particles of a first product being applied to seeds or particles of a second product being applied.

Example 3—the electrical control system of Example 1 or Example 2, wherein the processing logic is further configured to select different wavelengths of the multiple light sources to be illuminated when the products flow in the product line during an application pass.

Example 4—the electrical control system of Example 3, wherein the wavelength of each light source is selected to maximize a contrast of the response signals that indicate a reflectance of light from each product.

Example 5—the electrical control system of Example 3, wherein the different light sources comprise a first light source having a first wavelength and a second light source having a second wavelength.

Example 6—the electrical control system of any preceding Example, wherein the at least one sensor is positioned on or adjacent to the product line of the agricultural implement.

Example 7—the electrical control system of any preceding Example, further comprising a display device that is configured to display the product characteristics including color and product ratio.

Example 8—the electrical control system of any preceding Example, wherein the product line of the agricultural implement is applying the one or more products to an agricultural field for planting.

Example 9—electrical control system of any preceding Example, wherein the one or more products comprise seed and fertilizer being applied by the agricultural implement to the agricultural field.

Example 10—electrical control system of any preceding Example, wherein the product line of the agricultural implement is applying the one or more products including seed and fertilizer to an agricultural field for planting, wherein the agricultural implement is a planter.

Example 11—An electrical control system comprising: at least one sensor that is configured to alternate illumination of multiple light sources with each light source having a different wavelength while one or more products flow in a product line of an agricultural implement; a module to receive sensor data from the at least one sensor; and processing logic coupled to the module, the processing logic is configured to obtain the sensor data including images of the products flowing in the product line from the module, to determine color thresholds for analyzing the images of the products, and to determine product characteristics including color of each product to distinguish each product based on the images of the products.

Example 12—the electrical control system of Example 11, wherein the product characteristics comprise a ratio of seeds or particles of a first product being applied to seeds or particles of a second product being applied.

Example 13—the electrical control system of Example 11 or Example 12, wherein the processing logic is further configured to select different wavelengths of the multiple light sources to be illuminated when the products flow in the product line during an application pass.

Example 14—the electrical control system of Example 13, wherein the wavelength of each light source is selected to maximize a contrast of response signals that are obtained by capturing images of the different products with the at least one sensor.

Example 15—the electrical control system of Example 13, wherein the different light sources comprise a first light source having a first wavelength and a second light source having a second wavelength.

Example 16. The electrical control system of any of Examples 11 to 15, wherein the at least one sensor comprises a camera that is positioned on or adjacent to the product line of the agricultural implement.

Example 17—the electrical control system of any of Examples 11 to 16, wherein the at least one sensor is positioned on or adjacent to a main product line or a secondary product line of the product line, on a manifold tower, or on a manifold tower riser pipe.

Example 18—the electrical control system of any of Examples 11 to 17, wherein the product line of the agricultural implement is applying the one or more products to an agricultural field for planting.

Example 19—electrical control system of any of Examples 11 to 18, wherein the one or more products comprise seed and fertilizer being applied by the agricultural implement to the agricultural field.

Example 20—electrical control system of any of Examples 11 to 19, wherein the product line of the agricultural implement is applying the one or more products including seed and fertilizer to an agricultural field for planting, wherein the agricultural implement is a planter.

Example 21—A computer implemented method comprising: alternating illuminating of different light sources with each light source having a different wavelength for at least one sensor on an agricultural implement while products flow through a product line during an application pass of the agricultural implement; capturing sensor data including response signals for each product while the products flow through the product line of the agricultural implement; and analyzing the response signals for each product to determine product characteristics including color of each product to distinguish each product.

Example 22—the computer implemented method of Example 21, wherein the product characteristics comprise a ratio of seeds or particles of a first product being applied to seeds or particles of a second product being applied.

Example 23—the computer implemented method of any of Examples 21 to 22 further comprising selecting different wavelengths of light sources to be illuminated during the application pass based on reflectance of each product.

Example 24—the computer implemented method of any of Examples 21 to 23, wherein a wavelength of each light source is selected to maximize a contrast of response signals that are generated from the different products.

Example 25—the computer implemented method of any of Examples 21 to 24, wherein the different light sources comprise a first light source having a first wavelength and a second light source having a second wavelength.

Example 26—the computer implemented method of any of Examples 21 to 25, further comprising utilizing a blockage sensor or a seed or particle counter assembly for each row unit of the agricultural implement to count seeds or particles while each product flows through the product line of the agricultural implement during the agricultural application pass.

Example 27—the computer implemented method of any of Examples 21 to 26, wherein the product line of the agricultural implement is applying the one or more products to an agricultural field for planting.

Example 28—computer implemented method of any of Examples 21 to 27, wherein the one or more products comprise seed and fertilizer being applied by the agricultural implement to the agricultural field.

Example 29—computer implemented method of any of Examples 21 to 28, wherein the product line of the agricultural implement is applying the one or more products including seed and fertilizer to an agricultural field for planting, wherein the agricultural implement is a planter.

1. An electrical control system comprising:
at least one sensor that is configured to illuminate multiple light sources with each light source having a different wavelength and to sense one or more products flowing in a product line of an agricultural implement; and
processing logic coupled to the at least one sensor, the processing logic is configured to obtain sensor data from the at least one sensor, to determine response signals for each product based on the sensor data, and to analyze the response signals for each product to determine product characteristics including color of each product to distinguish each product.

2. The electrical control system of claim 1, wherein the product characteristics comprise a ratio of seeds or particles of a first product being applied to seeds or particles of a second product being applied.

3. The electrical control system of claim 1, wherein the processing logic is further configured to select different wavelengths of the multiple light sources to be illuminated when the products flow in the product line during an application pass.

4. The electrical control system of claim 3, wherein the wavelength of each light source is selected to maximize a contrast of the response signals that indicate a reflectance of light from each product.

5. The electrical control system of claim 3, wherein the different light sources comprise a first light source having a first wavelength and a second light source having a second wavelength.

6. The electrical control system of claim 1, wherein the at least one sensor is positioned on or adjacent to the product line of the agricultural implement.

7. The electrical control system of claim 1, further comprising a display device that is configured to display the product characteristics including color and product ratio.

8. The electrical control system of claim 1, wherein the product line of the agricultural implement is applying the one or more products to an agricultural field for planting.

9. The electrical control system of claim 1, wherein the one or more products comprise seed and fertilizer being applied by the agricultural implement to the agricultural field.

10. The electrical control system of claim 1, wherein the product line of the agricultural implement is applying the one or more products including seed and fertilizer to an agricultural field for planting, wherein the agricultural implement is a planter.

11. An electrical control system comprising:
at least one sensor that is configured to alternate illumination of multiple light sources with each light source having a different wavelength while one or more products flow in a product line of an agricultural implement;
a module to receive sensor data from the at least one sensor; and
processing logic coupled to the module, the processing logic is configured to obtain the sensor data including images of the products flowing in the product line from the module, to determine color thresholds for analyzing the images of the products, and to determine product characteristics including color of each product to distinguish each product based on the images of the products.

12. The electrical control system of claim 11, wherein the product characteristics comprise a ratio of seeds or particles of a first product being applied to seeds or particles of a second product being applied.

13. The electrical control system of claim 11, wherein the processing logic is further configured to select different wavelengths of the multiple light sources to be illuminated when the products flow in the product line during an application pass.

14. The electrical control system of claim 13, wherein the wavelength of each light source is selected to maximize a contrast of response signals that are obtained by capturing images of the different products with the at least one sensor.

15. The electrical control system of claim 13, wherein the different light sources comprise a first light source having a first wavelength and a second light source having a second wavelength.

16. The electrical control system of claim 11, wherein the at least one sensor comprises a camera that is positioned on or adjacent to the product line of the agricultural implement.

17. The electrical control system of claim 11, wherein the at least one sensor is positioned on or adjacent to a main product line or a secondary product line of the product line, on a manifold tower, or on a manifold tower riser pipe.

18. The electrical control system of claim 11, wherein the product line of the agricultural implement is applying the one or more products to an agricultural field for planting.

19. The electrical control system of claim 11, wherein the one or more products comprise seed and fertilizer being applied by the agricultural implement to the agricultural field.

20. The electrical control system of claim 11, wherein the product line of the agricultural implement is applying the one or more products including seed and fertilizer to an agricultural field for planting, wherein the agricultural implement is a planter.

21. A computer implemented method comprising:
alternating illuminating of different light sources with each light source having a different wavelength for at least one sensor on an agricultural implement while products flow through a product line during an application pass of the agricultural implement;
capturing sensor data including response signals for each product while the products flow through the product line of the agricultural implement; and
analyzing the response signals for each product to determine product characteristics including color of each product to distinguish each product.

22. The computer implemented method of claim 21, wherein the product characteristics comprise a ratio of seeds or particles of a first product being applied to seeds or particles of a second product being applied.

23. The computer implemented method of claim 21, further comprising selecting different wavelengths of light sources to be illuminated during the application pass based on reflectance of each product.

24. The computer implemented method of claim 21, wherein a wavelength of each light source is selected to maximize a contrast of response signals that are generated from the different products.

25. The computer implemented method of claim 24, wherein the different light sources comprise a first light source having a first wavelength and a second light source having a second wavelength.

26. The computer implemented method of claim 21, further comprising utilizing a blockage sensor or a seed or particle counter assembly for each row unit of the agricultural implement to count seeds or particles while each product flows through the product line of the agricultural implement during the agricultural application pass.

27. The computer implemented method of claim 21, wherein the product line of the agricultural implement is applying the one or more products to an agricultural field for planting.

28. The computer implemented method of claim 21, wherein the one or more products comprise seed and fertilizer being applied by the agricultural implement to the agricultural field.

29. The computer implemented method of claim 21, wherein the product line of the agricultural implement is applying the one or more products including seed and fertilizer to an agricultural field for planting, wherein the agricultural implement is a planter.
